(19) United States
(12) Patent Application Publication
(10) Pub. No.: US 2009/0112805 A1
(43) Pub. Date: Apr. 30, 2009

(54) METHOD, SYSTEM, AND COMPUTER PROGRAM PRODUCT FOR IMPLEMENTING SEARCH QUERY PRIVACY

(76) Inventors: Zachary Adam Garbow, Rochester, MN (US); Kurt walter Pinnow, Rochester, MN (US); Richard Michael Shok, Rochester, MN (US); William Maupin Stockdell, Byron, MN (US); Brent Allen Swartz, Chippewa Falls, WI (US); Oystein Thorsen, Houghton, MI (US)

Correspondence Address: IBM CORPORATION;ROCHESTER IP LAW DEPT 917, 3605 HIGHWAY 52 N, ROCHESTER, MN, 55901-7829, US

(21) Appl. No.: 11/930,493

(22) Filed: Oct. 31, 2007

(51) Int. Cl. G06F 17/30

(52) U.S. Cl. 707/3; 707/E17.108

(57) ABSTRACT

User privacy is protected by preventing certain unsafe search queries from being associated with the user when saved by a search engine. When an unsafe query is detected, the unsafe query is submitted to a proxy service, and the proxy service submits the query to a search engine preventing the query from being associated with the user. The user receives the search results from the proxy service. Query filtering only allows queries to be submitted directly to the search engine that do not provide personal information or information which may infer an undesirable trend when taken in aggregate with other submitted queries by that user.

### FIELD OF THE INVENTION

The present invention relates generally to the data processing field, and more particularly, relates a method, system and computer program product for implementing search query privacy.

### DESCRIPTION OF THE RELATED ART

Typically when a user submits a query as a logged-in user to a search engine provider, such as Google Inc., the query is associated with that user. Google Inc. offers a Personalized Search service. When a user chooses to stop storing searches in Personalized Search either temporarily or permanently, or to remove items, this merely removes the query from being considered for the user's customized searches and the query will not be used to improve the user's search results. However, it is common practice in the industry to maintain a separate logging system for auditing purposes and to help improve the quality of the search services for users. For example, this information is used to audit ads systems, understand which features are most popular to users, improve the quality of search results, and help combat vulnerabilities such as denial of service attacks.

Today many search engines are tracking users' search histories and are increasingly introducing features that utilize search history for improved accuracy of search results and feature enhancement. However, there is the risk of this information being accessed or released improperly.

For example, in one case, search histories for 650,000 users were released to researchers, with the users only identified by a number and not a name. Once this data became available on the World Wide Web (WWW), in some cases associations could be made between the queries and the actual identity of the user based on an analysis of the queries themselves, somewhat like putting the pieces of a puzzle together. Additionally, search histories can provide a treasure trove of data for identity thieves.

A need exists for an effective mechanism for implementing search query privacy

### SUMMARY OF THE INVENTION

Principal aspects of the present invention are to provide a method, system, and computer program product for implementing search query privacy. Other important aspects of the present invention are to provide such method, system, and computer program product for implementing search query privacy substantially without negative effect and that overcome many of the disadvantages of prior art arrangements.

In brief, a method, system, and computer program product are provided for implementing search query privacy. A query is received from a user. The query is processed to identify an unsafe query. When an unsafe query is detected, the unsafe query is submitted to a proxy service. The proxy service submits the query to a search engine and prevents the query from being associated with the user. The user receives the search results from the proxy service. An identified safe query is submitted directly to the search engine.

In accordance with features of the invention, the query filtering only allows queries to be submitted directly to the search engine that do not provide personal information or information which may infer an undesirable trend when taken in aggregate with other submitted queries by that user.

In accordance with features of the invention, the query processing includes combining the received query with previously submitted queries to determine whether the received query allows the search engine to infer a trend.

When a trend is identified, the user is informed of the identified trend before the query is submitted to the search engine. If the identified trend is safe or innocent then the user can select to submit the query to the search engine. If the trend includes personal information, then the user is informed and the query is routed through the proxy service so that the search engine cannot associate the query with the user in their account.

In accordance with features of the invention, the method keeps the user from accidentally submitting queries that lead to an undesirable trend or analysis. The method of the invention protects user privacy by preventing certain unsafe search queries from being associated with the user when saved by a search engine. The filtering mechanism to prevent unsafe queries from ever being submitted to the server under the user's name or IP address. The invention offers improved privacy while using existing search engines, while still allowing the user to benefit from advanced search features.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1A is a block diagram illustrating a search system for implementing search query privacy in accordance with the preferred embodiment;

FIG. 1B is a block diagram illustrating further details of a user search query computer system of the search system of FIG. 1A for implementing search query privacy in accordance with the preferred embodiment;

FIG. 2 is a flow chart illustrating exemplary steps for implementing a query submission method to implement search query privacy in accordance with the preferred embodiment;

FIG. 3 is a flow chart illustrating exemplary steps for implementing a method to identify an unsafe query to implement search query privacy in accordance with the preferred embodiment;

FIG. 4 is a block diagram illustrating a computer program product in accordance with the preferred embodiment.

### DETAILED DESCRIPTION OF THE PREFERRED EMBODIMENTS

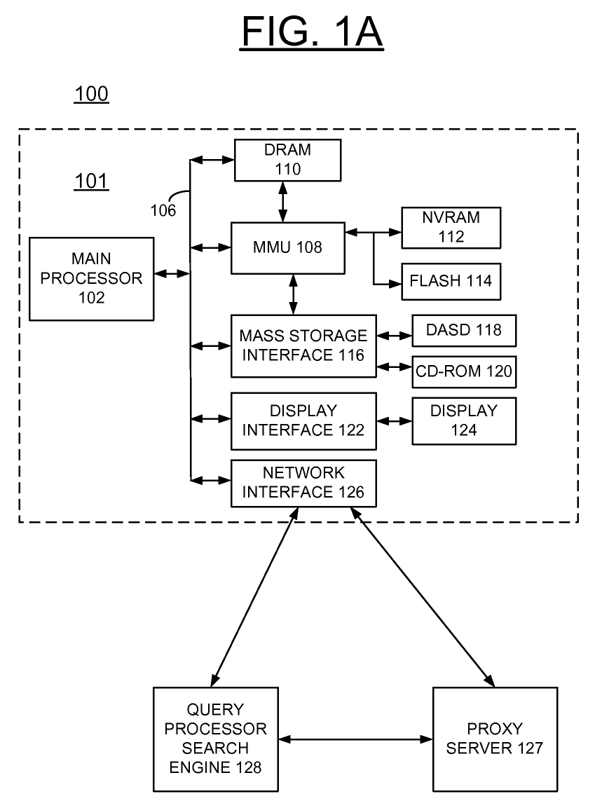

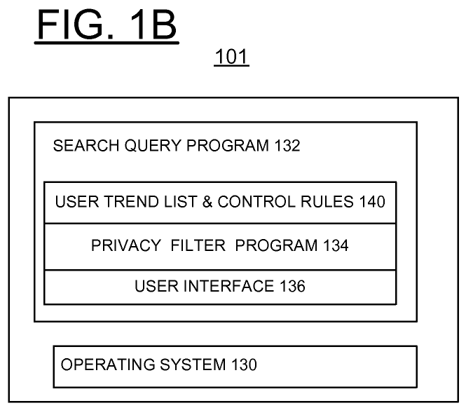

Having reference now to the drawings, in FIGS. 1A and 1B, there is shown an exemplary search computer system generally designated by the reference character 100 for implementing search query privacy methods in accordance with the preferred embodiment. Computer system 100 includes a user search query computer system 101 processing search queries for a user and implementing search query privacy methods of the invention.

User search query computer system 101 includes a main processor 102 or central processor unit (CPU) 102 coupled by a system bus 106 to a memory management unit (MMU) 108 and system memory including a dynamic random access memory (DRAM) 110, a nonvolatile random access memory (NVRAM) 112, and a flash memory 114. A mass storage interface 116 coupled to the system bus 106 and MMU 108 connects a direct access storage device (DASD) 118 and a CD-ROM drive 120 to the main processor 102. User search query computer system 101 includes a display interface 122 coupled to the system bus 106 and connected to a display 124. User search query computer system 101 includes a network interface 126 for connection with a proxy server 127 of the preferred embodiment and a query processor search engine 128.

Computer search system 100 including user search query computer system 101 is shown in simplified form sufficient for understanding the present invention. The illustrated computer system 101 is not intended to imply architectural or functional limitations. The present invention can be used with various hardware implementations and systems and various other internal hardware devices, for example, multiple main processors.

In accordance with features of the invention, a proxy service is implemented with the proxy server 127 that is not associated with the search engine 128. It should be understood that in alternate embodiments of the invention the proxy service could function on the client's machine or the user search query computer system 101, instead of a separate proxy server 127. For example, the proxy service could be implemented as a browser plug-in program or standalone application on computer system 101. The invention allows the user to select user privacy features and to use whichever search engine 128 including, for example, Google, Yahoo, Microsoft or other search engine.

As shown in FIG. 1B, user search query computer system 101 includes an operating system 130, a search engine program 132, a privacy filter program 134 of the preferred embodiment, and a user interface 136. User trend list and privacy control rules 140 are identified and stored for implementing search query privacy methods of the preferred embodiment. The user selectively configures types of information that should be kept private at a high level, such as location and interests, and trends to be blocked that are stored with the user trend list and privacy control rules 140.

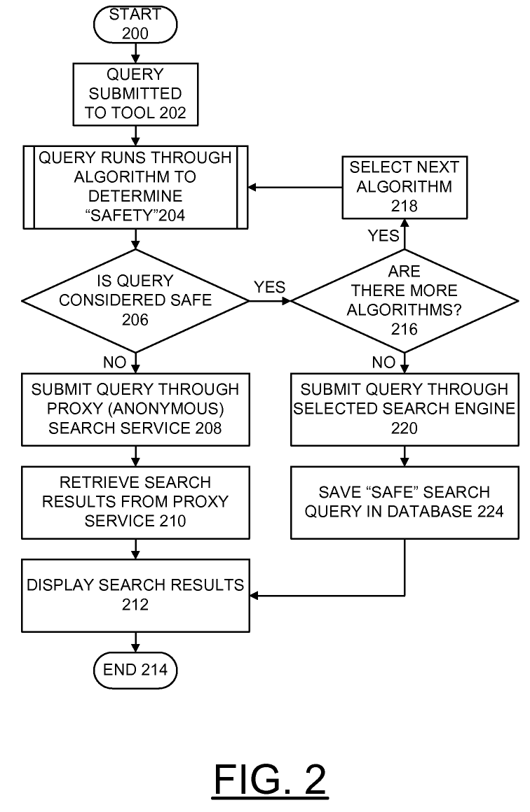

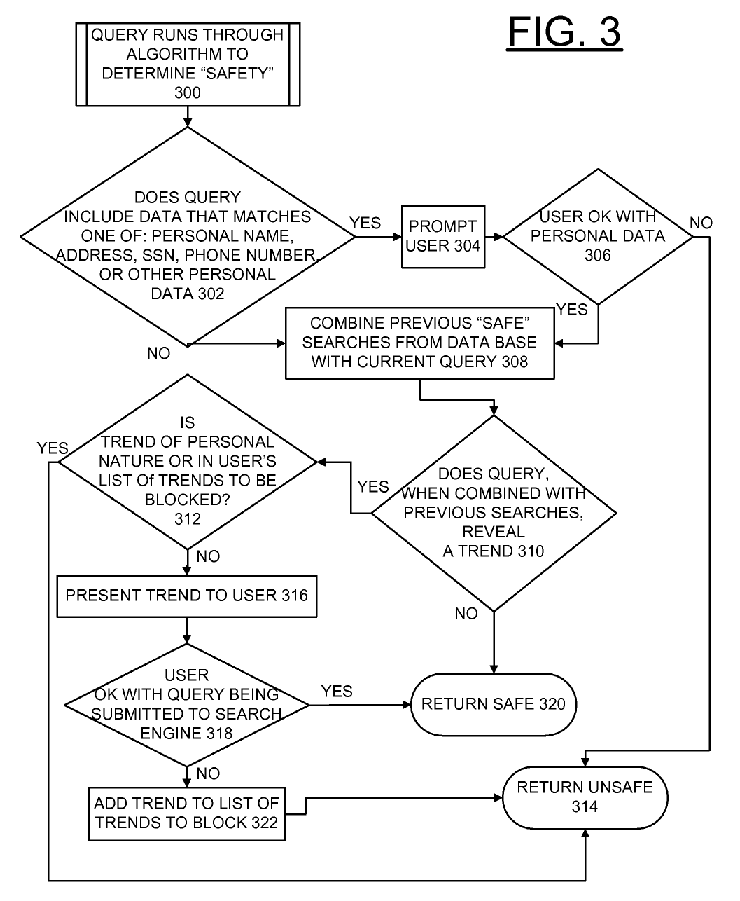

Various commercially available computers can be used for computer system 101 and server computer 127, for example, an IBM server computer, such as an IBM System i™ system. CPU 102 is suitably programmed by the search engine program 132 and the privacy filter program 134 to execute the flowcharts of FIGS. 2 and 3 and for implementing search query privacy in accordance with the preferred embodiment.

In accordance with features of the preferred embodiments, the privacy filter program 134 or application framework serves as a filter between a user's search queries and the search engine server 128, in order to intelligently control which queries are sent to the search engine server 128 to be used with that user's history, and which queries should be submitted anonymously via the proxy server 127 and thus not associated with the user's history. In accordance with features of the preferred embodiments, when the user submits a query, before the query is actually sent to the search engine 128, the privacy filter program 134 compares the query to the user's search history to determine if it is a safe or unsafe query with respect to that user's privacy, that is whether the query might contain potentially sensitive information or might it identify the user when analyzed.

In accordance with features of the preferred embodiments, a safe query is one that when analyzed with previous queries by the user, does not compromise that user's privacy, including personal information such as name, address, contact information, specific interests. Similarly, an unsafe query is one that when analyzed in conjunction with previous queries by the user, may indicate information about the user. A safe query as defined by the present invention allows each user to configure a safe threshold to a selected setting that matches a desired comfort level for the user.

In accordance with features of the preferred embodiments, when the privacy filter program 134 identifies the query as safe, the query is then submitted directly to the search engine 128 and associated with the user, with the results returned. The query is stored in the search engine's history. If the query is identified as unsafe, the user is prompted and can choose to submit the query anonymously through a proxy service, such as proxy server 127, so that the search engine 128 cannot save it into the user's history. Proxy techniques are known in the art, and know proxy methods are applied to the unsafe query that is submitted without being associated with a username or IP address.

Queries submitted anonymously cannot take advantage of features that utilize the particular user's search history.

Referring to FIG. 2, there are shown exemplary steps for implementing a query submission method to implement search query privacy in accordance with the preferred embodiment starting at a block 200. A query is submitted to the tool or when the privacy filter program 134 of the preferred embodiment as indicated at a block 202.

A subroutine or algorithm to determine is safety of the query is performed as indicated at a block 204. FIG. 3 illustrates an exemplary subroutine or algorithm to determine query safety as performed at block 204.

In accordance with features of the preferred embodiments, a filtering framework is provided so that algorithms for identifying “unsafe” queries can be written as plug-in or definition files, much like antivirus software allows virus definition updates. A simple heuristic algorithm advantageously is used to identify known patterns of names, numbers or other personal data in particular formats that indicate a search query, which may reveal personal information. More complex algorithms also can be written by the service provider and downloaded as a service, billing the user for the service.

As indicated at a decision block 206, checking is performed to determine whether the query is considered safe. When the query is not considered safe at decision block 206, then the query is submit through a proxy search service that is anonymous and the query is submitted without being associated with a username or IP address as indicated at a block 208. Then the search results are retrieved from the proxy service, such as proxy server 127, as indicated at a block 210. Then the search results are displayed for the user as indicated at a block 212. This completes the process as indicated at a block 214. When the query is considered safe at decision block 206, then checking for more algorithms is performed as indicated at a decision block 216. If another algorithm is identified, the additional algorithm is selected as indicated at a block 218. Then selected algorithm to determine is safety of the query is performed at block 204. Otherwise, when another algorithm is not identified, the query is submitted through a user selected search engine as indicated at a block 220. The safe search query is saved in a database as indicated at a block 224. Then the search results are displayed for the user as indicated at block 212. This completes the process as indicated at block 214.

Referring to FIG. 3, there are shown exemplary steps for implementing a method to identify an unsafe query subroutine to implement search query privacy in accordance with the preferred embodiment as indicated at a block 300. Checking is performed to determine whether the query contains or includes data that matches one of personal name, address, social security number (SSN), phone number or other personal data as indicated at a decision block 302.

When the query includes data that matches one of personal name, address, social security number (SSN), phone number or other personal data, the user is notified as indicated at a block 304. Checking whether the user accepts or is OK with the personal data is performed as indicated at a decision block 306.

In accordance with features of the preferred embodiments, a predefined number or last X safe queries that were submitted to the search engine are saved, and this history is used when analyzing and filtering subsequent queries. If it is determined, upon analysis, that a subsequent query would make previously submitted queries unsafe, then the query itself is marked as unsafe and the user is prompted whether to submit it anonymously.

When the user is OK with the personal data, then the current query is combined with previous safe searches from the data base as indicated at a block 308. Checking whether the query, when combined with previous searches, reveals a trend as indicated at a decision block 310.

When the query when combined with previous searches reveals a trend, then checking whether the trend is of a personal nature or in the user's list of trends to be blocked is performed as indicated at a decision block 312. If the trend is of a personal nature or in the user's list of trends to be blocked, then the query is returned as unsafe as indicated at a block 314.

In accordance with features of the preferred embodiments, privacy levels are configured by the user in order to control the level of automation, and/or how frequently the user is prompted about unsafe queries. If a user is very concerned about privacy, the user may set the threshold higher so that the system is more stringent on filtering the queries, and prompts the user more often for unsafe queries. Additionally, the user can configure which types of information should be kept private at a high level, such as location or interests.

In accordance with features of the preferred embodiments, the privacy filter program 134 of the preferred embodiment determines what inferences and associations a search engine might make with respect to the user based on the user's queries. If submitting a particular query may allow the search engine to label the user as a “civil war buff,” then the privacy filter program 134 prompts or specifies this label to the user, who may then choose to submit that query anonymously rather than through their user account. Furthermore, the privacy filter program 134 of the preferred embodiment can submit fake queries that are spoof queries, to counteract previous queries in the search history that may be preventing new queries from being identified as safe.

When the trend is of a personal nature or in the user's list of trends to be blocked, then the trend is presented to the user as indicated at a block 316.

Checking whether the user selects that the query be submitted to the search engine is performed as indicated at a decision block 318. When the user selects that the query be submitted to the search engine, then the query is returned as safe as indicated at a block 320.

When the user selects that the query not be submitted to the search engine, then the trend is added to the list of trends to block as indicated at a block 322. Then the query is returned as unsafe at block 314.

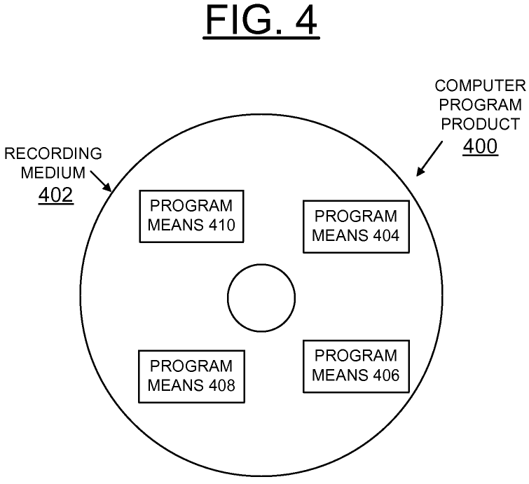

Referring now to FIG. 4, an article of manufacture or a computer program product 400 of the invention is illustrated. The computer program product 400 includes a recording medium 402, such as, a floppy disk, a high capacity read only memory in the form of an optically read compact disk or CD-ROM, a tape, or another similar computer program product. Recording medium 402 stores program means 404, 406, 408, 410 on the medium 402 for carrying out the methods for implementing search query privacy of the preferred embodiment in the search system 100 and search query computer system 101 of FIGS. 1A and 1B.

A sequence of program instructions or a logical assembly of one or more interrelated modules defined by the recorded program means 404, 406, 408, 410, direct the computer system 101 for implementing search query privacy of the preferred embodiment.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems.

While the present invention has been described with reference to the details of the embodiments of the invention shown in the drawing, these details are not intended to limit the scope of the invention as claimed in the appended claims.

What is claimed is:

1. A computer method for implementing search query privacy for a user comprising:
receiving a query from the user;
processing the query to identify an unsafe query;
responsive to identifying said unsafe query, submitting the unsafe query to a proxy service; said proxy service submitting the query to a search engine and preventing the submitted query from being associated with the user;
receiving the search results for the user from the proxy service; and
responsive to identifying a safe query, submitting said identified safe query directly to the search engine.

2. The computer method for implementing search query privacy as recited in claim 1 wherein processing the query to identify an unsafe query includes filtering the received query to identify personal information.

3. The computer method for implementing search query privacy as recited in claim 1 includes storing said identified safe query submitted directly to the search engine.

4. The computer method for implementing search query privacy as recited in claim 3 wherein processing the query to identify an unsafe query includes filtering the received query to identify query information which infers a trend to be blocked when analyzed with said stored identified safe query submitted directly to the search engine.

5. The computer method for implementing search query privacy as recited in claim 3 wherein processing the query to identify an unsafe query includes combining the received query with a plurality of stored submitted queries to determine whether the received query includes information to infer a trend.

6. The computer method for implementing search query privacy as recited in claim 5 includes identifying a trend, informing the user of the identified trend.

7. The computer method for implementing search query privacy as recited in claim 5 includes receiving a user selection to submit the query to the search engine, identifying the query as safe and submitting the query to the search engine.

8. The computer method for implementing search query privacy as recited in claim 5 includes identifying a trend to be blocked, responsive to said identified trend, identifying the received query as said unsafe query, and submitting said identified unsafe query to said proxy service.

9. The computer method for implementing search query privacy as recited in claim 8 includes notifying the user of said identified trend to be blocked.

10. The computer method for implementing search query privacy as recited in claim 1 wherein said proxy service submitting the query to a search engine and preventing the query from being associated with the user includes said proxy service submitting the query without being associated with a username and a user internet protocol (IP) address.

11. The computer method for implementing search query privacy as recited in claim 10 includes said proxy service submitting the query anonymously.

12. The computer method for implementing search query privacy as recited in claim 1 includes storing a predetermined trend to be blocked.

13. The computer method for implementing search query privacy as recited in claim 12 wherein processing the query to identify an unsafe query includes analyzing the query together with a plurality of stored safe query submitted directly to the search engine to identify said predetermined trend to be blocked.

14. A method for deploying computing infrastructure, comprising integrating computer readable code into a computing system, wherein the code in combination with the computing system is capable of performing the method of claim 1.

15. A computer-readable medium encoded with a computer program product for implementing search query privacy in a computer system, said computer-readable medium consisting one of a floppy disk, a hard disk, a high capacity read only memory in the form of an optically read compact disk or CD-ROM, a DVD, a tape, a read only memory (ROM), and a random access memory (RAM), said computer program product including instructions executed by the computer system to cause the computer system to perform the steps of:
receiving a query from the user;
processing the query to identify an unsafe query;
responsive to identifying said unsafe query, submitting the unsafe query to a proxy service; said proxy service submitting the query to a search engine and preventing the submitted query from being associated with the user;
receiving the search results for the user from the proxy service; and
responsive to identifying a safe query, submitting said identified safe query directly to the search engine.

16. The computer-readable medium encoded with a computer program product for implementing search query privacy as recited in claim 15 wherein processing the query to identify an unsafe query includes filtering the query to identify personal information.

17. The computer-readable medium encoded with a computer program product for implementing search query privacy as recited in claim 15 storing said identified safe query submitted directly to the search engine.

18. The computer-readable medium encoded with a computer program product for implementing search query privacy as recited in claim 17 wherein processing the query to identify an unsafe query includes analyzing the query with said stored submitted safe query to identify a trend.

19. The computer-readable medium encoded with a computer program product for implementing search query privacy as recited in claim 15 includes notifying the user of an identified trend.

20. The computer-readable medium encoded with a computer program product for implementing search query privacy as recited in claim 15 storing trends to be blocked.
